(19) United States
(12) Patent Application Publication
(10) Pub. No.: US 2010/0228622 A1
(43) Pub. Date: Sep. 9, 2010

(54) Messaging Interface for Advertisement Submission

(75) Inventor: Siddharth Vijayakrishnan, Bangalore (IN)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/706,774

(22) Filed: Feb. 17, 2010

Related U.S. Application Data
(60) Provisional application No. 61/157,054, filed on Mar. 3, 2009.

(51) Int. Cl. G06Q 30/00; G06Q 20/00; H04W 4/12

(52) U.S. Cl. 705/14.44; 705/14.55; 705/14.52; 455/466

(57) ABSTRACT

Methods, systems, and apparatus, including computer program products, in which submission of targeted advertisements can be facilitated using text messaging. Text message received from advertisers can include advertisement information and target audience information. Such information can be used to generate an advertisement for the advertiser. The generated advertisement can be provided for targeted distribution to users.

### CROSS-REFERENCE TO RELATED APPLICATION

This application claims the benefit under 35 U.S.C. §119(e) of U.S. Patent Application No. 61/157,054, titled “Messaging Interface for Advertisement Submission,” filed Mar. 3, 2009, the entire disclosure of which is incorporated herein by reference.

### BACKGROUND

This document relates to content submission.

The rise of the Internet has enabled access to a wide variety of content items, e.g., video and/or audio files, web pages for particular subjects, news articles, etc. Such access to these content items has likewise enabled opportunities for targeted advertising. For example, content items of particular interest to a user can be identified by a search engine in response to a user query. The query can include one or more search terms, and the search engine can identify and, optionally, rank the content items based on the search terms in the query and present the content items to the user (e.g., according to the rank). This query can also be an indicator of the type of information of interest to the user. By comparing the user query to a list of keywords specified by an advertiser, it is possible to provide targeted advertisements to the user. Another form of online advertising is advertisement syndication, which allows advertisers to extend their marketing reach by distributing advertisements to additional partners. For example, third party online publishers can place an advertiser's text or image advertisements on web pages that have content related to the advertisement. As the users are likely interested in the particular content on the publisher webpage, they are also likely to be interested in the product or service featured in the advertisement. Accordingly, such targeted advertisement placement can help drive online customers to the advertiser's website.

However, some advertisers still lack the ability to submit advertisements to publishers based upon a lack of Internet access, a lack of comfort with the advertisement submission process, etc. Such advertisers would benefit from additional mechanisms for submitting advertisements that go beyond traditional advertisement submission mechanisms.

### SUMMARY

In general, the subject matter of this application relates to providing a messaging interface operable to receive advertisements submissions. In general, one aspect of the subject matter described in this specification can be embodied in a method for receiving advertisement submissions. The method can include the actions of: receiving one or more messages in a messaging format from a device associated with an advertiser, the one or more messages including advertising information and target audience information; generating an advertisement based upon the message; and providing the advertisement for targeted distribution based upon the target audience information. Other embodiments of this aspect include corresponding methods, apparatus, and computer program products.

Various optional advantages and features can include increasing the ability of business owners to participate in online advertising. Another optional advantage can include providing targeted advertising based upon an expected audience associated with many online publishers and/or search queries. Other optional advantages can include an instruction menu provided in a messaging format and a prepay billing plan. These various optional advantages and features can be separately realized and need not present in any particular embodiment.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online environment.

FIG. 2 is a block diagram of an example messaging interface for advertisement submission.

FIG. 3 is a flow diagram of an example process for adjusting participation probability for a content item in a content item selection process.

FIG. 4 is a flow diagram of another example process for adjusting participation probability for a content item in a content item selection process.

FIG. 5 is block diagram of an example computer system on which the participation probability adjustment subsystem can reside.

Like reference numbers and designations in the various drawings indicate like elements.

### DETAILED DESCRIPTION

### §1.0 Overview

In general, the subject matter of this specification relates to providing a messaging based interface for advertisement submission. A message can be received from an advertiser and parsed to identify advertisement information included in the message. The advertisement information can be used to generate an online advertisement. The online advertisement can be distributed to users, for example, through a network of publishers and/or included with search results provided by a search engine.

For example, a business owner who does not have an internet presence might be unable to submit an advertisement through online submission process due to being unsophisticated or unfamiliar with internet technology or lack of availability of an internet connection. Such business owners could benefit from online advertising, but are unable to participate. However, in many countries text messaging (e.g., short message service (SMS), enhanced messaging service (EMS), and multimedia messaging service (MMS), among others) is widely used and is very popular. An interface can be constructed whereby such business owners can submit advertisements for inclusion in online advertising mechanisms.

Although various examples are described with reference to advertisements, the systems and methods described in this specification can also facilitate the identification and serving of other types of content items having measurable performance or quality parameters, such as videos, articles, reviews, etc.

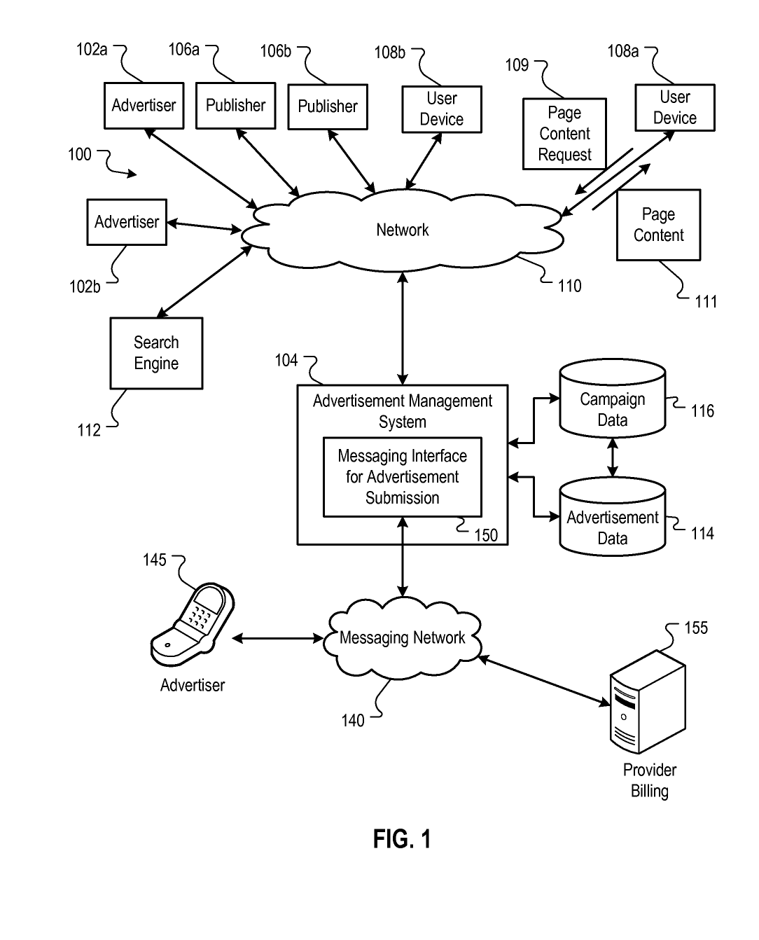

The subject matter of this specification can be implemented in an online environment, such as the example online environment 100 shown in FIG. 1. The online environment 100 can facilitate the identification and serving of content items, e.g., web pages, advertisements, etc., to users. A computer network 110, such as a local area network (LAN), wide area network (WAN), the Internet, or a combination thereof, connects online advertisers 102a and 102b, an advertisement management system 104, publishers 106a and 106b, user devices 108a and 108b, and a search engine 112. Although only two online advertisers (102a and 102b), two publishers (102a and 102b) and two user devices (108a and 108b) are shown, the online environment 100 may include many thousands of advertisers, publishers and user devices.

In some implementations, a messaging network 140 (such as, e.g., an SMS capable network, an EMS capable network, an MMS capable network, etc.) can connect mobile users 145 who wish to provide online advertisements through using their mobile phone to the advertisement management system 104 using a messaging interface for advertisement submission 150. Although only one mobile user 145 is shown, the online environment 100 may include many thousands of mobile users using the messaging interface for advertisement submission 150.

### §1.1 Advertisement Publishing and Tracking

In the online environment 100, one or more advertisers 102a, 102b and/or 145 can directly, or indirectly, enter, maintain, and track advertisement information in the advertising management system 104. In some implementations, the advertisements can be in the form of graphical advertisements, such as banner advertisements, text only advertisements, image advertisements, audio advertisements, video advertisements, advertisements combining one of more of any of such components, etc., or any other type of electronic advertisement. The advertisements may also include embedded information, such as a links, meta-information, and/or machine executable instructions, such as HTML or JavaScript™.

A user device, such as user device 108a, can submit a page content request 109 to a publisher or the search engine 112. In some implementations, the page content 111 can be provided to the user device 108a in response to the request 109. The page content can include advertisements provided by the advertisement management system 104, or can include executable instructions, e.g., JavaScript™, that can be executed at the user device 108a to request advertisements from the advertisement management system 104. Example user devices 108 include personal computers, mobile communication devices, television set-top boxes, etc.

Advertisements can also be provided from the publishers 106. For example, one or more publishers 106a and/or 106b can submit advertisement requests for one or more advertisements to the system 104. The system 104 responds by sending the advertisements to the requesting publisher 106a or 106b for placement on one or more of the publisher's web properties (e.g., websites and other network-distributed content). The advertisements can include embedding links landing pages, e.g., pages on the advertisers 102 websites, that a user is directed to when the user clicks an ad presented on a publisher website. The advertisement requests can also include content request information. This information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, a publisher 106 can combine the requested content with one or more of the advertisements provided by the system 104. This combined page content 109 and advertisements can be sent to the user device 108 that requested the content (e.g., user device 108a) as page content 111 for presentation in a viewer (e.g., a browser or other content display system). The publisher 106 can transmit information about the advertisements back to the advertisement management system 104, including information describing how, when, and/or where the advertisements are to be rendered (e.g., in HTML or JavaScript™).

Publishers 106a and 106b can include general content servers that receive requests for content (e.g., articles, discussion threads, music, video, graphics, search results, web page listings, information feeds, etc.), and retrieves the requested content in response to the request. For example, content servers related news content providers, retailers, independent blogs, social network sites, or any other entity that provides content over the network 110 can be a publisher.

Advertisements can also be provided through the use of the search engine 112. The search engine 112 can receive queries for search results. In response, the search engine 112 can retrieve relevant search results from an index of documents (e.g., from an index of web pages). An exemplary search engine 112 is described in the article S. Brin and L. Page, “The Anatomy of a Large-Scale Hypertextual Search Engine,” Seventh International World Wide Web Conference, Brisbane, Australia and in U.S. Pat. No. 6,285,999. Search results can include, for example, lists of web page titles, snippets of text extracted from those web pages, and hypertext links to those web pages, and may be grouped into a predetermined number of (e.g., ten) search results.

The search engine 112 can also submit a request for advertisements to the system 104. The request may include a number of advertisements desired. This number may depend on the search results, the amount of screen or page space occupied by the search results, the size and shape of the advertisements, etc. The request for advertisements may also include the query (as entered or parsed), information based on the query (such as geo-location information, whether the query came from an affiliate and an identifier of such an affiliate), and/or information associated with, or based on, the search results.

The search engine 112 can combine the search results with one or more of the advertisements provided by the system 104. This combined information can then be forwarded to the user device 108 that requested the content as the page content 111. The search results can be maintained as distinct from the advertisements, so as not to confuse the user between paid advertisements and presumably neutral search results.

The advertisers 102, user devices 108, and/or the search engine 112 can also provide usage information to the advertisement management system 104. This usage information can include measured or observed user behavior related to advertisements that have been served, such as, for example, whether or not a conversion or a selection related to an advertisement has occurred. The system 104 performs financial transactions, such as crediting the publishers 106 and charging the advertisers 102 based on the usage information. Such usage information can also be processed to measure performance metrics, such as a click-through rate (“CTR”), conversion rate, and other measurable performance metrics.

A click-through can occur, for example, when a user of a user device, selects or “clicks” on a link to a content item returned by the publisher or the advertising management system. The CTR is a performance metric that is obtained by dividing the number of users that clicked on the content item, e.g., a link to a landing page, an advertisement, or a search result, by the number of times the content item was delivered. For example, if a link to a content item is delivered 100 times, and three persons click on the content item, then the CTR for that content item is 3%. Other usage information and/or performance metrics (e.g., cost per mile (CPM)) can also be used.

A “conversion” occurs when a user consummates a transaction related to a previously served advertisement. What constitutes a conversion may vary from case to case and can be determined in a variety of ways. For example, a conversion may occur when a user clicks on an advertisement, is referred to the advertiser's web page, and consummates a purchase there before leaving that web page. A conversion can also be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Other actions that constitute a conversion can also be used.

### §2.0 Messaging Interface for Advertisement Submission

Advertisements can be submitted to the advertising management system 104 in a variety of ways. In some implementations, the advertising management system 104 can facilitate submission of advertisements through a messaging interface 150. The messaging interface 150 can receive messages (e.g., SMS messages, EMS messages, MMS messages, etc.) from advertisers 145 that would like to advertise through the advertising management system 104. Such messages can be transmitted through a messaging network 140 to the advertising management system 104.

In some implementations, the messaging interface 150 can provide instructions for submitting advertisements to the advertising managements system 104 using the messaging interface. Such instructions, for example, can be provided using an online interface such as, for example, a web-based interface. In other examples, the instructions can be provided within one or more messages sent to the advertiser 145.

In those examples using messaging to distribute instructions to advertisers 145, the messaging interface 150 can include an automated interactive messaging response system whereby users can send a message to the messaging interface 150 and receive a response from the messaging interface 150 based upon the content of the message. For example, an initial message to the messaging interface 150 might elicit a response message providing a menu for accessing various categories of instructions, the menu instructing the user to send a reply message with the text “1” to access instructions on the general message format to use when submitting a message, a reply message with the text “2” to receive instructions on billing, a reply message with the text “3” to receive instruction on retrieving performance statistics, etc. Other menu structures and/or hierarchies can be used.

In some implementations, the messaging interface 150 can include a parsing component operable to parse messages received from advertisers 145 based upon the format specified by the instructions. For example, the instructions might indicate separating fields for different advertisement components by a slash character (“1”) or some other delimiter. In such implementations, the fields can include, for example, an advertisement creative field (e.g., including a header/title field and a body field) as input for generating a creative, a bidding information field identifying bidding information for participation of the advertisement in auctions, and billing information from which an advertiser's account can be debited when some action is detected with respect to the advertisement (e.g., when the advertisement is served to a user, when the advertisement is selected by a user, when a conversion occurs as a result of the advertisement, etc.). In one example, an advertiser might want to submit an advertisement for a bicycle. The advertiser in this example can send a text message to the messaging interface 150 including the content: Bicycle for sale!/Folding Citizen Bike, sparingly used—Free dropoff in the Bay area/bicycle, bike, folding bike, citizen bike. The first field can be a title field, and in this example would be “Bicycle for sale!” The second field can be a creative field, and in this example would be “Folding Citizen Bike, sparingly used—Free dropoff in the Bay area.” The third field can include the keywords to be used for the advertisement, and in this example would be “bicycle,” “bike,” “folding bike” and “Citizen bike.” In some implementations, the text message can also include billing information for the advertiser using any of the delimiters identified above. The parser can determine whether any portion of the advertisement, bidding or billing information is missing and can send a text message to the advertiser requesting any of the missing information.

In some implementations, the messaging interface 150 can elicit successive messages that include different elements of information describing the advertisement to be created. Following each message sent by the advertiser, the messaging interface can provide Instructions identifying what the contents of the next message sent by the advertiser 145 to the messaging interface 150 should include. For example, the messaging interface 150 can receive a first message that contains the advertisement. In this example, the messaging interface 150 can respond to the receipt of the advertisement with a request for bidding information. The advertiser 145 can then reply to the request for bidding information with the bids he/she wants to enter for the advertisement placement. After receiving the bidding information, the messaging interface 150 can send a message to the advertiser 145 requesting billing information.

The messaging interface 150 can generate an advertisement from the initial message, and once the billing information is received, the advertisement along with associated bidding information can be released to the advertisement data store 114 for distribution using the advertising management system 104.

In some implementations, a lead capture instruction can be included with the advertisement in the advertising management system 104. The lead capture instruction can provide an action to be taken as a result of the user selecting the advertisement. In some implementations, the lead capture instruction can instruct a browser to retrieve a landing page upon selection of the advertisement. Because the advertiser has submitted the advertisement through a messaging interface 150, the messaging interface 150 can automatically generate a landing page for the advertisement. In those implementations where a landing page for the advertisement is provided, when the user selects the advertisement, he/she will be directed to the landing page. The landing page can provide additional information (e.g., address, coupons, etc.) for the advertiser. Such additional information can be collected, for example, based upon listings, messages received from the advertiser, etc.). In other implementations, selection of the advertisement can cause a call to be placed in those instances where the user selects the device using a mobile communications device (e.g., cellular phone) or a computer with internet telephony. In further implementations, selection of the advertisement can cause a text message to be sent to the advertiser with contact information supplied by the user. In still further implementations, the advertisement can direct the user to call a number associated with the advertisement management system 104. When a call is received, the advertisement management system 104 can record a selection of the advertisement and forward the call to the advertiser.

When an advertisement is served, a billing component included in the messaging interface 150 can track the advertisement to determine whether an advertisement account associated with the advertisement should be debited (e.g., based upon the billing paradigm (e.g., cost per click (CPC), cost per impression (CPI), etc.) associated with the advertisement). In some examples, the billing component can charge a third party account (e.g., bank account, credit card, mobile phone, etc.) to open an advertisement account for the advertiser 145 with the advertising management system 104. Thereby, charges from advertisement placements can be debited from the advertisement account. In other examples, the charge can be made to the third party account each time an action is taken with regard to the advertisement.

In some implementations, the advertiser 145 can specify a maximum amount to be spent on the campaign. In those examples where the advertiser 145 maintains an advertising account with the advertising management system 104, the maximum amount to be spent on the campaign can be managed by the amount of money placed into the advertisement account. When the account has been exhausted, the advertisement is not served again until the advertiser 145 places more money into the advertisement account. In those examples where a third party account is debited each time an action is taken with regard to an advertisement, the user can specify a maximum amount to be debited from the third party account. In some examples, the advertiser 145 can provide additional approval to raise the budget for the campaign.

In some implementations, the messaging interface can provide performance metrics to the advertiser 145 using a messaging format (e.g., SMS, EMS, MMS, etc.). The performance metrics, for example, can include a number of times the advertisement has been served, a number of selections of the advertisement, a cost per impression, an average price paid for advertisement placements, most popular search terms for users that viewed and/or selected the advertisement, etc. The performance metrics can be used by the advertiser 145 to judge the effectiveness of the campaign.

### §3.0 Messaging Interface Subsystems

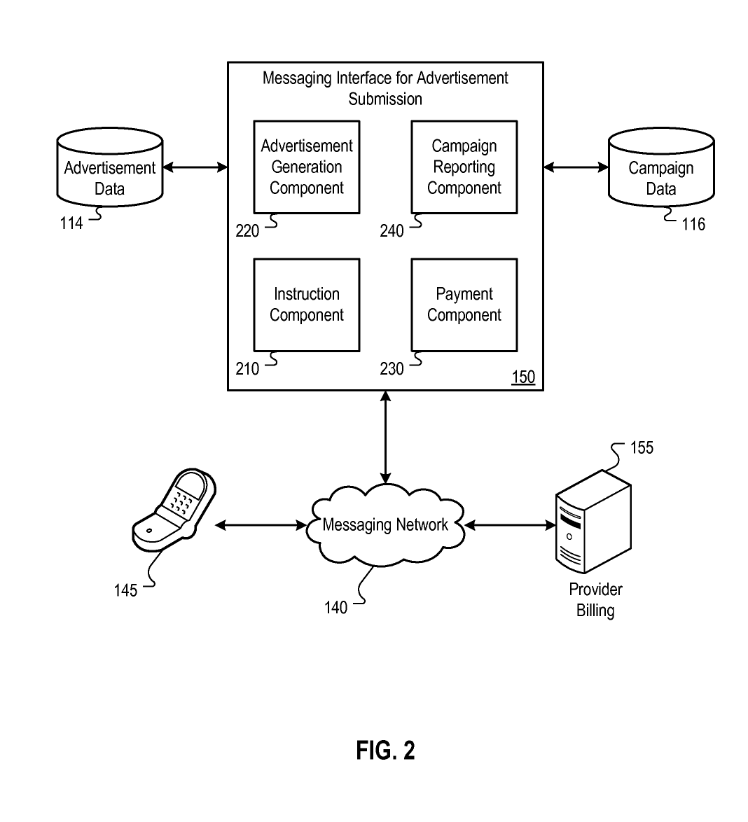

FIG. 2 is a block diagram of an example messaging interface for advertisement submission 150. The messaging interface for advertisement submission 150 can facilitate the submission of advertisements for use in online targeted advertising using messaging formats (e.g., SMS, EMS, MMS, etc.). In some implementations, the messaging interface 150 can include an instruction component 210, an advertisement generation component 220, a payment component 230, and a campaign reporting component 240.

The instruction component 210 can be operable to provide instructions for formatting of submissions to the messaging interface 150. In some implementations, the instructions can provide a text messaging template to which the advertiser can reply and fill the relevant information into the correct fields of the template. In other implementations, the instructions can provide an interactive message interface whereby the user can request instructions for specific parts of the submission. In still other implementations, the instruction component 210 can provide successive instructions to the advertiser 145 based upon successful submission of successive components of an advertisement. For example, the advertiser 145 can submit a title. The instruction component 210 can then provide instructions for submission of body text for the creative. Upon receiving body text for the creative, the instruction component can provide instructions for submission of target information, bidding information, billing information, etc.

The advertisement generation component 220 can be operable to generate an advertisement based upon one or more submissions received from the advertiser 145. Based upon the information received in one or more messages from the advertiser 145 the advertisement generation component 220 can generate an advertisement, including, e.g., one or more of an advertisement creative, a linked page, target audience, bidding information, and/or billing information. In those implementations where the advertiser submits an advertisement in a single message, the advertisement generation component 220 can parse the message to separate the component parts of the advertisement (e.g., header/title, body text, link, target information, bidding information, billing information, etc.). In such implementations, the advertisement generation component 220 can inspect the message to ensure that an advertisement can be accurately created from the message. If the advertisement generation component 220 is unable to generate the advertisement from the message, the advertisement generation component 220 can direct the instructions component 210 to request the advertiser resubmit the advertisement. Alternatively, the advertisement generation component 220 can direct the instructions component to send a request to the advertiser to submit only that portion of the advertisement which was not derived from one or more earlier messages.

In those implementations where the advertiser submits the advertisement in several different messages, the advertisement generation component 220 can identify the components of the advertisement based upon the different messages received from the advertiser 145. In such implementations, the advertisement generation component 220 can inspect each of the messages to ensure that a current message is in proper format. For example, the advertisement generation component can direct the instructions component 210 to provide instructions for submitting a next advertisement component of the advertisement if the current message is in the proper format or to provide instructions for resubmitting a current advertisement component if the current message is in an improper or unrecognized format.

The payment component 230 can be operable to debit a user account responsive to a performance metric associated with the advertisement. For example, in those implementations where the performance metric is based upon a cost per click metric, the payment component 230 can debit an advertiser account when the advertisement is selected by a user. In further examples, a bidding system can be used to select advertisements for display to a user. In such examples, the payment component 230 can debit the advertiser's account based upon auction results associated with the presentation of the advertisement. In various implementations, the advertiser account can be a third party account, or the advertiser account can be account with the advertising management system.

In some implementations, the payment component can store an advertising budget for the advertisement as provided by the advertiser. In such implementations, the payment component, for example, can remove the advertisement from eligibility for targeted distribution to users based upon the budget. The budget, for example, can be specified by the advertiser based upon the size of the advertiser's account, or can be based upon an amount provided by the advertiser 145 during submission of the advertisement.

The campaign reporting component 240 can provide statistical metrics to the advertiser 145 regarding his/her advertising campaign. In various implementations, the statistical metrics can include, for example, the number of times an advertisement has been served, a number of times the advertisement has been selected, conversions resulting from the advertisement display, length of campaign, average cost per impression, average cost per click, etc. The performance metrics can be provided to the advertiser 145 using a messaging protocol.

### §4.0 Example Messaging Interface Processes

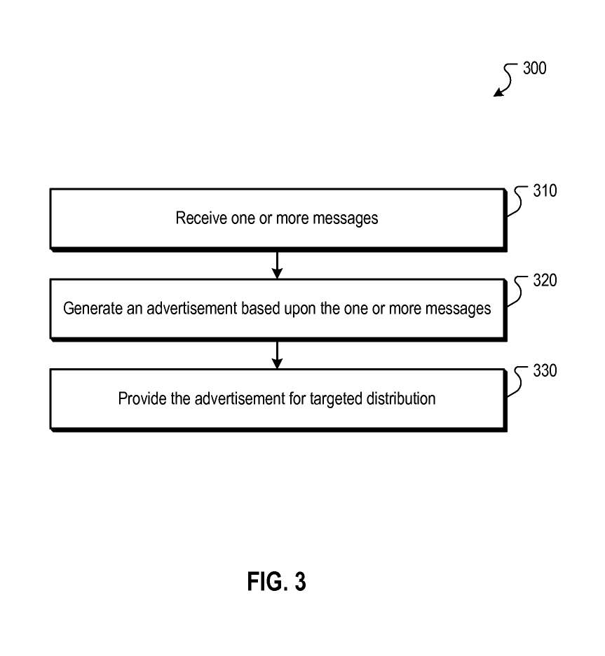

FIG. 3 is a flow diagram of an example process 300 for adjusting participation probability for a content item in a content item selection process. At stage 310, one or more messages are received. The one or more messages can be received, for example, by a messaging interface (e.g., messaging interface 150 of FIG. 2) in conjunction with an advertisement generation component (e.g., advertisement generation component 220 of FIG. 2). In some implementations, the entire advertisement is received in a single message, while in other implementations, the advertisement is received over multiple messages. The one or more message can include both advertisement information (e.g., a creative) and target audience information (e.g., targeted search terms, demographic information, etc.)

At stage 320, an advertisement is generated based upon the one or more messages. The advertisement can be generated, for example, by a messaging interface (e.g., messaging interface 150 of FIG. 2) in conjunction with an advertisement generation component (e.g., advertisement generation component 220 of FIG. 2). An advertisement in a single message can include delimiters operable to separate the various fields that can be requested by the messaging interface (e.g., including title/header, advertisement body, link, target audience, bidding information, billing information, etc.) Advertisements received in multiple messages can be parsed according to the order in which the messages were received. In some implementations, instructions can be provided to the advertiser to alert the advertiser as to how to format the advertisement submission. In various implementations, the advertisement can be a targeted text advertisement, a targeted graphical advertisement, a targeted video advertisement, a targeted audio advertisement, etc.

At stage 330, the advertisement is provided for targeted distribution. The advertisement can be provided for targeted distribution, for example, by an advertising management system (e.g., advertising management system 104 of FIG. 1). In some implementations, the advertisement can be served with search results when search terms related to the advertisement are submitted to a search engine. In other implementations, the advertisement can be served based upon a request from a web publisher for advertisements to be included within his/her web page.

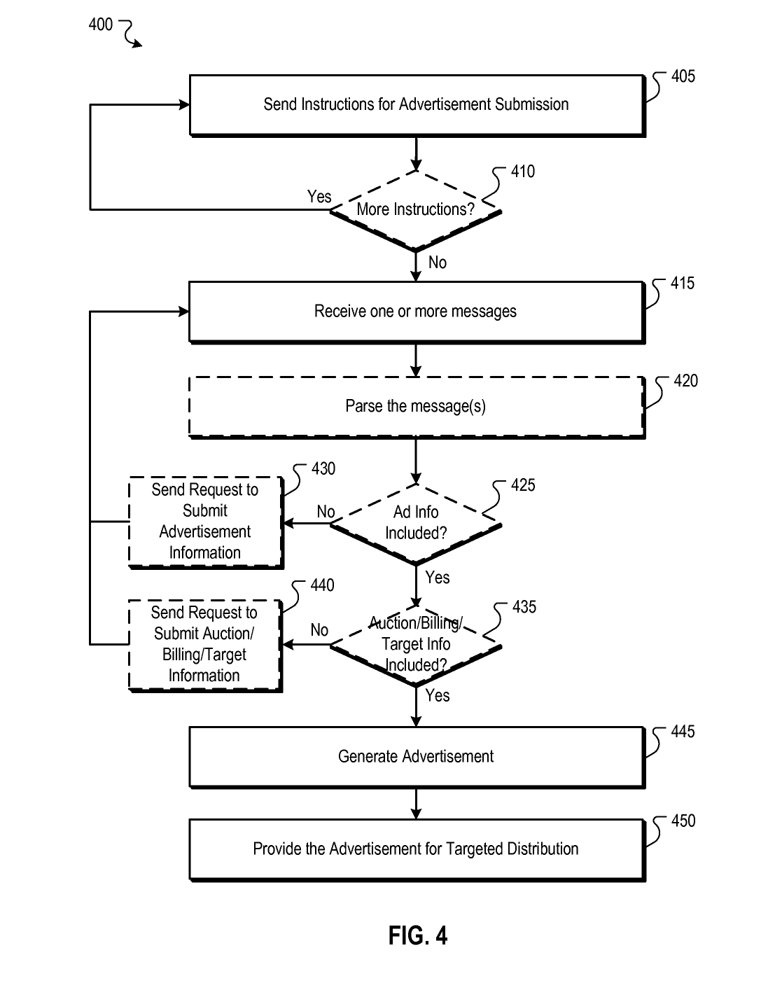

FIG. 4 is a flow diagram of another example process 400 for adjusting participation probability for a content item in a content item selection process. At stage 405, instructions for advertisement submission are sent to an advertiser. The instructions can be sent, for example, by a messaging interface (e.g., messaging interface 150 of FIG. 2) in conjunction with an instruction component (e.g., instruction component 210 of FIG. 2). In some implementations, the instruction component can instruct the advertiser to submit the various components of an advertisement in several different messages. In other implementations, the instruction component can instruct the advertiser to submit the various components of the advertisement in a single message, with each component marked by some delimiter.

At stage 410, a decision is made whether there are more instructions to provide to the advertiser. The decision of whether more instructions are to be provided can be made, for example, by an instructions component (e.g., instructions component 210 of FIG. 2). In some implementations, the instructions component provides instructions in a manner similar to an interactive message response system, whereby the advertiser sends a message to the instruction component including an identification of which instruction menu page is desired, and the instruction component responds with the requested instruction menu page. In other implementations, the instruction component provides all of the instruction pages at once, and the advertiser can navigate the pages based upon a structured order in which the instruction messages were sent.

If there are more instruction pages to send, the process 400 returns to stage 405. However, if there are no more instruction pages to send, one or more messages can be received from the advertiser at stage 415. The one or more messages can be received, for example, by a messaging interface (e.g., messaging interface 150 of FIG. 2) in conjunction with an advertisement generation component (e.g., advertisement generation component 220 of FIG. 2). In some implementations, the entire advertisement is received in a single message, while in other implementations, the advertisement is received over multiple messages. The one or more message can include both advertisement information (e.g., a creative) and target audience information (e.g., targeted search terms, demographic information, etc.)

At stage 420, the message is parsed. The message can be parsed, for example, by an advertisement generation component (e.g., advertisement generation component 220 of FIG. 2). An advertisement in a single message can include delimiters operable to separate the various fields that can be requested by the messaging interface (e.g., including title/header, advertisement body, link, target audience, bidding information, billing information, etc.). Such a message is thereby parsed based upon the delimiters within the message. Advertisements received in multiple messages can be parsed according to the order in which the messages were received. In some implementations, instructions can be provided to the advertiser to alert the advertiser as to how to format the advertisement submission.

At stage 425, a determination is made whether advertisement information is included in the one or more messages. The determination can be made, for example, by the advertisement generation component (e.g., advertisement generation component 220 of FIG. 2). If the one or more messages do not include advertisement information, the process 400 can send a request to submit advertisement information at stage 430. The request to submit advertisement information can be sent, for example, by the instructions component (e.g., instructions component 210 of FIG. 2).

If advertisement information is included in the one or more messages, the process 400 can determine whether the one or more messages include auction, billing and/or target audience information. The determination of whether the one or more messages include auction, billing, and/or target audience information can be made, for example, by the advertisement generation component (e.g., advertisement generation component 220 of FIG. 2). If the one or more messages do not include advertisement information, the process 400 can send a request to submit advertisement information at stage 440. The request to submit advertisement information can be sent, for example, by the instructions component (e.g., instructions component 210 of FIG. 2).

If the auction, billing and/or target audience information is included in the one or more messages, the process 400 can generate an advertisement at stage 445. The advertisement can be generated, for example, by a messaging interface (e.g., messaging interface 150 of FIG. 2) in conjunction with an advertisement generation component (e.g., advertisement generation component 220 of FIG. 2). In various implementations, the advertisement generated can be a targeted text advertisement, a targeted graphical advertisement, a targeted video advertisement, a targeted audio advertisement, etc.

At stage 450, the advertisement is provided for targeted distribution. The advertisement can be provided for targeted distribution, for example, by an advertising management system (e.g., advertising management system 104 of FIG. 1). In some implementations, the advertisement can be served with search results when search terms related to the advertisement are submitted to a search engine. In other implementations, the advertisement can be served based upon a request from a web publisher for advertisements to be included within his/her web page.

In some implementations, spam detection processes are used to identify spam messages that may be sent by use of the messaging interface. Messages classified as spam messages are ignored and not processed further. Such techniques can include comparing sending addresses (e.g., numbers) of the received message to a list of known spam addresses. If the sending address of the received message is on the spam address list, then the message is classified as spam. Another technique includes comparing the received messages to other received messages that are received within a time window. If a number of messages are highly similar, then the messages are classified as spam. Other spam detection processes can also be used.

### 5.0 Example Computer System

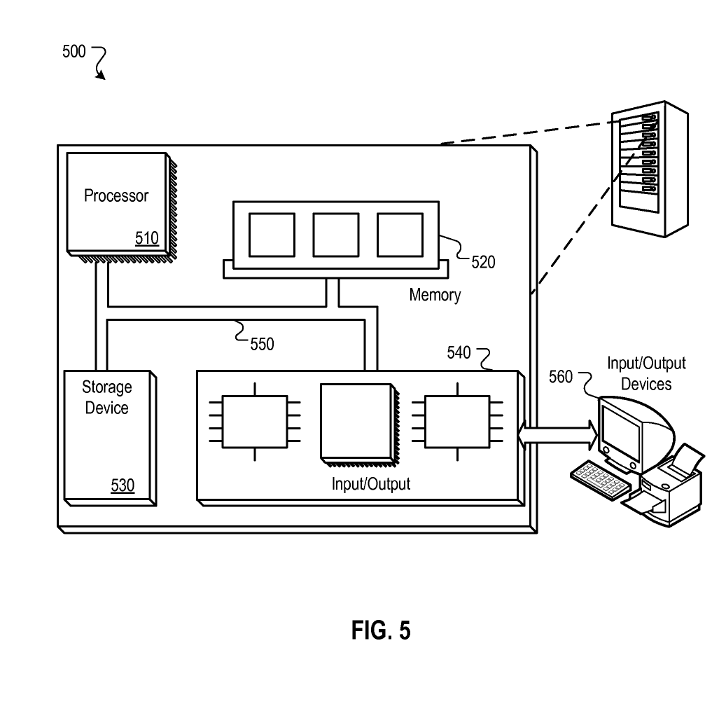

FIG. 5 is block diagram of an example computer system 500. The system 500 includes a processor 510, a memory 520, a storage device 530, and an input/output device 540. Each of the components 510, 520, 530, and 540 can, for example, be interconnected using a system bus 1350. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can, for example, include a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

The messaging interface for advertisement submission 150 can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium. The messaging interface for advertisement submission 150 can be distributively implemented over a network, such as a server farm, or can be implemented in a single computer device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer implemented method, comprising:
receiving a text message in a text messaging format at an advertisement management system from a device associated with an advertiser, the text message including an advertisement creative and target audience information;
generating at the advertisement management system an advertisement based upon the text message, the advertisement including the creative; and
generating at the advertisement management system a lead capture instruction for the advertisement, the lead capture instruction configured to be executed in response to a selection of the advertisement by a user; and
providing the advertisement and lead capture instruction for targeted distribution based upon the target audience information.

2. The computer implemented method of claim 1, further comprising sending an error text message to the device if the advertisement cannot be generated based upon the text message.

3. The computer implemented method of claim 1, further comprising providing an instructions interface comprising instructions for submitting the text message to generate the advertisement.

4. The computer implemented method of claim 3, wherein the instructions interface comprises a plurality of instruction text messages, the plurality of instruction text messages comprising instructions for sending the text message to generate the advertisement.

5. The computer implemented method of claim 4, wherein the instructions are operable to notify the user how to compose the text message to result in generation of the advertisement.

6. The computer implemented method of claim 1, further comprising parsing the text message to determine whether billing information and advertisement information is included within the text message.

7. The computer implemented method of claim 6, further comprising:
if the text message does not include billing information, sending a request to the advertiser to submit billing information; and
if the text message does not include advertisement information, sending a request to the advertiser to submit advertisement information.

8. The computer implemented method of claim 1, further comprising collecting statistics related to serving the advertisement to users, the statistics measuring the effectiveness of the advertisement.

9. The computer implemented method of claim 8, further comprising debiting an account associated with the advertiser based upon billing information received from the advertiser.

10. The computer implemented method of claim 8, further comprising:
generating a reporting page in the text messaging format; and
providing the reporting page to the advertiser.

11. Software stored in one or more computer readable media and comprising instructions executable by a processing system, upon such execution causing the processing system to perform operations comprising:
receiving a text message in a text messaging format at an advertisement management system from a device associated with an advertiser, the text message including an advertisement creative and target audience information;
generating at the advertisement management system an advertisement based upon the text message, the advertisement including the advertisement creative; and
generating at the advertisement management system a lead capture instruction for the advertisement, the lead capture instruction configured to be executed in response to a selection of the advertisement by a user; and
providing the advertisement and lead capture instruction for targeted distribution based upon the target audience information.

12. The software of claim 11, further operable to cause the processing system to perform an operation comprising sending an error text message to the device if the advertisement cannot be generated based upon the text message.

13. The software of claim 11, further operable to cause the processing system to perform an operation comprising providing an instructions interface comprising instructions for submitting the text message to generate the advertisement.

14. The software of claim 13, wherein the instructions interface comprises a plurality of instruction text messages, the plurality of instruction text messages comprising instructions for sending the text message to generate the advertisement.

15. The software of claim 14, wherein the instructions are operable to notify the user how to compose the text message to result in generation of the advertisement.

16. The software of claim 11, further operable to cause the processing system to perform an operation comprising parsing the text message to determine whether billing information and the advertisement creative is included within the text message.

17. The software of claim 16, further operable to cause the processing system to perform operations comprising:
if the text message does not include billing information, sending a request to the advertiser to submit billing information; and
if the text message does not include advertisement information, sending a request to the advertiser to submit the advertisement creative.

18. The software of claim 11, further operable to cause the processing system to perform an operation comprising collecting statistics related to serving the advertisement to users, the statistics measuring the effectiveness of the advertisement.

19. The software of claim 18, further operable to cause the processing system to perform an operation comprising debiting an account associated with the advertiser based upon billing information received from the advertiser.

20. The software of claim 18, further operable to cause the processing system to perform operations comprising:
generating a reporting page in the text messaging format; and
providing the reporting page to the advertiser.
